(19) United States
(12) Patent Application Publication
(10) Pub. No.: US 2026/0220018 A1
(43) Pub. Date: Jul. 30, 2026

(54) Method and system for assessing stability of given working state in state-changing processes

(71) Applicant: Eyal KARNI, Tel Aviv-Yafo (IL)

(72) Inventor: Eyal KARNI, Tel Aviv-Yafo (IL)

(21) Appl. No.: 19/405,862

(22) Filed: Dec. 2, 2025

Related U.S. Application Data
(60) Provisional application No. 63/727,758, filed on Dec. 4, 2024.

(51) Int. Cl. G06F 11/34; A63F 13/56

(52) U.S. Cl. CPC G06F 11/3457; A63F 13/56

(57) ABSTRACT

A system and method for assessing stability of a given working state in state-changing processes is disclosed. It comprises of receiving data representing a working state with multiple components and parameters, determining an optimality score for the working state, evaluating potential working states that may develop from the given state, determining scores for each potential state, arranging all scores along a scoring distribution function representing destabilization values, assigning destabilization values to potential scores based on their positions, and computing a stability score based on all destabilization values. The invention provides quantitative assessment of state resilience to perturbations, enabling improved system performance prediction and optimization across diverse domains including manufacturing, vehicle configurations, automated processes, biological and chemical systems, and strategic games.

### CROSS REFERENCE TO RELATED APPLICATIONS

This application claims the benefit of priority of U.S. Provisional Patent Application No. 63/727,758, filed Dec. 4, 2024, the contents of which are incorporated herein by reference in their entirety.

### TECHNICAL FIELD

The present invention relates to methods and systems for evaluating and quantifying the stability of working states within dynamic systems. More specifically, it involves a computer-implemented method and system for assessing the resilience and robustness of a given state in state-changing processes, applicable to a variety of technological domains.

### BACKGROUND

Modern systems across diverse technological domains, such as manufacturing, automated processes, machine learning models, biological and chemical systems, vehicle configurations, and even strategic games like chess and checkers, operate within dynamic environments where working states change continuously. A working state in such systems is defined by a set of components and parameters, whose interactions determine the system's functionality at a given moment. Depending on the application, the working state may be formed automatically or configured manually.

The stability of a working state, or its ability to sustain consistent functionality amid potential perturbations, is crucial for ensuring system efficiency. Nonetheless, traditional methods often focus solely on optimizing a single state without evaluating its robustness or adaptability to changes, resulting in potential inefficiencies or failures when conditions deviate from the ideal. For instance: (a) In manufacturing processes, changes in input materials or machine settings can lead to suboptimal outcomes if stability is not assessed, increasing material waste, impacting reliability and durability of manufactured products, and accelerating wear and tear of manufacturing machinery; (b) In automated and machine learning processes, a solution that is optimal in one scenario might perform poorly with slight variations in data, which may translate to increased use of computing resources and higher energy consumption; (c) Vehicle or machine configurations often face challenges in maintaining consistent performance when external conditions, such as load or terrain change, or possibly, other adjustments are applied; (d) In biological and chemical processes, a consistent performance in a variety of external environments is paramount to achieving reliable reactions or biological functions; (e) For strategic games, assessing the stability of a board state can guide players toward resilient strategies, rather than momentary gains. This can be a deciding factor, as it is often very hard for humans to maintain an advantage in an unstable environment.

There is a distinct lack of robust methodologies to evaluate the stability of working states in these diverse scenarios. While some prior work exists for specific applications, such as the turbine engine stability assessment described in U.S. Pat. No. 10,352,824 (Long et al.), which focuses on analyzing frequency components and applying filtering techniques to determine engine operational stability, these approaches tend to be domain-specific and do not provide a generalizable framework for stability assessment across diverse state-changing processes.

Current approaches often fail to quantify how susceptible a state is to destabilization when transitioning to nearby potential states, limiting the predictive capabilities necessary to ensure long-term system performance. Existing methods typically focus on optimizing individual states without considering the broader stability landscape or the resilience of a given state to perturbations that may arise during operation.

### SUMMARY OF THE INVENTION

The present invention provides a computer-implemented method and system to assess the stability of a given working state within a state-changing process. The computer processor implementing the method evaluates not only the optimality of a state but also its resilience to destabilization, addressing the limitations of traditional state-assessment methods. Furthermore, the processor may evaluate not only the stability of the given working state, but also the stability of potential working states that use different combinations of parameters for the same components in the process. After assessing the stability of a given working state versus that of potential working states, the system may recommend or perform specific changes to parameters that would result in a more stable working state, thereby increasing the efficiency of the process. Depending on the technological process or system that this is implemented on, such a reconfiguration of the parameters toward a more stable working state can have substantial positive technical effect such as improving the operation of the system, accelerating processes, reducing computing resources, material waste, wear and tear and energy consumption, and enhancing reliability and robustness of manufactured products.

The method begins by obtaining, by the processor, the data representing a working state, comprising multiple components and associated parameters. The data may be obtained from a single or plurality of inputs from a single or multiple devices or sensors, including the computing device the processor is installed on.

The processor analyzes the data representing the working state and assigns a score to the working state based on its parameters, reflecting its level of optimality. The processor then identifies potential working states that can evolve from the given state, and assigns each of them a score based on their parameters. The processor then arranges the scores representing the different potential working states across a distribution function, and assigns each score a destabilization value based on its deviation from the original state.

After generating destabilization values for all potential working states, the processor computes the stability score of the given working state based on the average of destabilization values of the potential working states that can directly evolve from the given working state, offering a comprehensive measure of the state's resilience.

The processor may then proceed with evaluating stability scores of potential working states, offering an insight into more stable alternatives for operation of the process. When one or more stabler potential working states are identified, the processor may recommend or perform the change of parameters to switch into one of such potential working states.

This methodology allows for a systematic evaluation of stability, enabling systems to maintain consistent performance under varying conditions, anticipate potential failures and adjust proactively, and optimize not just for peak performance but for long-term durability.

By doing this, the invention contributes significantly to enhancing the reliability and robustness of dynamic systems in a wide range of fields.

### DESCRIPTION OF THE PREFERRED EMBODIMENTS

The following embodiments are presented solely for purposes of illustration and to provide examples of how the disclosed method and system may be implemented in various contexts. It will be appreciated that additional variations, modifications, and applications may be employed without departing from the principles of the present disclosure.

A preferred embodiment of the present invention relates to computer-implemented method for assessing and optimizing stability of a working state in a state-changing process, comprising the following steps performed by at least one processor of at least one computing device:

receiving data representing a given working state in the state-changing process, wherein the working state comprises a plurality of components and a plurality of parameters, each of said plurality of components is associated with at least one of said plurality of parameters; determining a given score of the given working state based on at least one of the plurality of parameters, wherein the given score represents the optimality of the given working state;

evaluating a plurality of potential working states that may be developed from the given working state; determining a plurality of potential scores, each corresponding to one of the plurality of potential working states; arranging the given score and plurality of potential scores along a scoring distribution function representing a range of destabilization values; assigning a destabilization value within the range of destabilization values to each of the plurality of potential scores based on its position on the scoring distribution function; computing a stability score of the given working state, wherein the stability score is the average of all destabilization values assigned to the plurality of potential scores. The term “average” in this and following embodiments may refer to arithmetic mean average, weighted average or expected value.

In some embodiments, the state-changing process corresponds to operation of a system comprising one or more devices coupled to the processor, wherein the processor is configured to obtain parameter data associated with components of the system from the devices and to compute a stability score of a working state defined by the obtained parameters.

In one embodiment, the state-changing process corresponds to an automated production line comprising multiple machines such as conveyors, presses, robotic manipulators, cutting systems, and inspection stations. The processor may be coupled to one or more sensors associated with these machines, including vibration sensors, motor current sensors, optical alignment sensors, torque monitors, and temperature probes. The received parameters may represent, for example, device load levels, synchronization timing between machines, alignment offsets, or thermal conditions. By evaluating potential working states derived from variations in these parameters, the processor may determine a stability score indicative of a likelihood of machine misalignment, motor stall, thermal overload, or other destabilizing events in the production process.

In another embodiment, the state-changing process may involve dynamic operation of an electrical power distribution network. The processor may receive parameters from substation devices such as voltage sensors, current transformers, phasor measurement units, and circuit breaker monitors. These parameters may represent instantaneous voltage levels, reactive and real power flows, frequency deviations, and transformer loading. The method may evaluate potential working states associated with fluctuations in load demand or switching operations, and may compute a stability score reflecting the risk of grid instability, voltage collapse, or cascading failures resulting from the current operating state.

In some embodiments, the state-changing process relates to real-time control of an autonomous vehicle. The processor may obtain parameter data from on-board devices such as LiDAR modules, radar sensors, inertial measurement units, wheel encoders, steering angle sensors, and camera systems. The working state may include vehicle position, heading, velocity, acceleration, wheel slip, steering angle, and sensor fusion confidence metrics. Potential working states may represent predicted future driving conditions or sensor inconsistencies. The computed stability score may serve to identify conditions likely to result in control oscillations, degraded localization quality, or reduced trajectory reliability.

In another example embodiment, the state-changing process may involve operation of a chemical reaction system such as a batch or continuous reactor. The processor may receive parameters obtained from temperature probes, pressure sensors, flow meters, pH sensors, and spectroscopic analyzers. The working state may include reactant concentrations, reaction temperature, vessel pressure, mixing rates, or catalyst activity. By generating and evaluating potential working states based on variations in these parameters, the processor may compute a stability score indicative of conditions that may lead to thermal runaway, insufficient mixing, stratification, or reaction inefficiency.

In some embodiments, the method is applied to thermal management of a data center. The processor may receive parameters from devices such as rack-mounted temperature sensors, coolant flow sensors, fan speed monitors, humidity sensors, and server power consumption meters. The working state may include thermal load distribution, airflow rates, coolant temperature, fan speed, and server utilization patterns. The processor may analyze potential working states representing predicted thermal fluctuations or cooling system degradation. The resulting stability score may indicate susceptibility to overheating, airflow imbalance, or cooling inefficiency.

In another embodiment, the state-changing process concerns coordinated motion of a robotic arm comprising multiple actuators. The processor may receive joint angle data, encoder feedback, torque sensor readings, motor temperature values, and force sensor outputs. The working state may represent joint configurations, actuator loads, movement velocities, and end-effector forces. By evaluating potential working states derived from small variations in these parameters, the processor may compute a stability score reflecting an increased likelihood of oscillatory behavior, actuator overload, or mechanical stress that could reduce positioning accuracy.

In some embodiments, the state-changing process corresponds to operation of one or more wind turbines. The processor may obtain sensory data including wind speed measurements from anemometers, blade pitch angles, generator load readings, vibration levels, and rotational speed. The working state may include aerodynamic load distribution, torque output, turbine yaw position, and turbulence intensity. The method may evaluate potential working states associated with changing wind conditions or mechanical wear patterns. The stability score may quantify the likelihood of aerodynamic stall, excessive vibration, generator overload, or other destabilizing events.

These embodiments are not exhaustive and are only given as examples of specific systems that can be monitored and optimized in accordance with the method disclosed herein. The method can be applied to a variety of other technical applications.

In another embodiment of the method, the computing device of the disclosed method further comprising a user interface and the processor is further configured to display the stability score on the user interface.

In another embodiment, the processor is further configured to compute, based on the stability score of the given working state, at least one recommendation of an optimized working state characterized by a higher stability score, wherein said optimized working state is different from the given working state by at least one parameter.

In another embodiment, the processor issues a command to change at least one parameter to switch from the given working state to one of the at least one recommendation of an optimized working state.

According to another embodiment, the method further comprising: analyzing, by the processor, a combination of at least one of the plurality of parameters in the given working state to determine the given score of the given working state, and a combination of at least one of the plurality of parameters in each of the plurality of potential working states to determine the potential score of the potential working state. The method may also include analyzing external components that may affect the stability of the working state, to determine its score.

In another embodiment, the processor is further configured to display the at least one recommendation on a user interface coupled to the processor, and obtain an instruction to switch from the given working state to one of the at least one recommendation of an optimized working state.

According to another embodiment, the state-changing process is performed by the processor.

In another embodiment, the state-changing process is performed by at least one device electronically controlled by the processor. The device may be electronic or electromechanical, and may be a device external to the computing device where the processor is, part of the computing device or the computing device itself. For example, machinery in a production line may consist of a device or several devices controlled by the processor, where each device has at least one component with a variable parameter that may affect the stability of the working state in the production process.

These embodiments are provided solely as illustrative examples of systems in which the disclosed method may be implemented. They are not intended to be exhaustive or to limit the scope of the invention in any way. The method may be applied to numerous other technical processes and system configurations without departing from the spirit or scope of the present disclosure.

In another embodiment, the method further comprises analyzing, by the processor, a combination of at least one of the plurality of parameters in the given working state to determine the given score of the given working state, and a combination of at least one of the plurality of parameters in each of the plurality of potential working states to determine the potential score of the potential working state.

In another embodiment, the at least one processor includes a first processor and a second processor of a second computing device in communication with the first processor, and at least one of the following steps performed by the second processor: evaluating a plurality of potential working states that may be developed from the given working state; analyzing a combination of at least one of the plurality of parameters in the given working state to determine the given score of the given working state; and analyzing a combination of at least one of the plurality of parameters in each of the plurality of potential working states to determine the potential score of each potential working state.

In another embodiment, at least one of the steps carried out by the second processor is under a predetermined restriction or configuration.

In another embodiment, the method further comprising: receiving, by the processor, the given score of the given working state and the potential score of each of the plurality of potential working states from a database of working state scores stored in a non-transitory memory.

In another embodiment, the method further comprising: receiving, by the processor, the plurality of potential working states that may be developed from the given working state from a database of working states stored in a non-transitory memory.

According to another embodiment, the plurality of potential scores having a positive difference from the given score are assigned a neutral destabilization value and the scoring distribution function is a half-negative scoring distribution function. The half negative-scoring distribution function is a distribution function that satisfies the condition of being constant at or above the given score.

In another embodiment, the plurality of potential scores having a negative difference from the given score are assigned a neutral destabilization value and the scoring distribution function is a half-positive scoring distribution function. The half-positive scoring distribution function is a distribution function that satisfies the condition of being constant at any score at or below the given score.

In another embodiment, the step of determining a plurality of potential scores is based on the combination of the plurality of parameters in each of the plurality of potential working states, wherein each of the plurality of potential scores represents the optimality of the potential working state it is associated with.

In another embodiment, the average of all destabilization values is a weighted average based on the plurality of potential scores.

In another embodiment, the average of all destabilization values is a geometric average with a constant offset function

$$\sqrt[\vert x \vert]{{\prod }_{x ∈ X} ( c + x )}$$

applied to each element, where c is a constant; and X is a set of the destabilization values.

In accordance with another embodiment, the plurality of potential working states is randomly selected from a plurality of working states obtained by the processor

In another embodiment, each of the plurality of potential working states is assigned a unique numeral ranking and the average of all destabilization values is a weighted average based on the unique numeral rankings of the potential working states.

In another embodiment, the processor is configured to perform the evaluation of the plurality of potential working states under at least one of: a filtering criterion based on potential scores, or a predetermined restriction on processor operation; wherein the filtering criterion comprises at least one of a difference limit or a fraction limit; and wherein the predetermined restriction on processor operation comprises at least one of a timeout limit, a node search limit, or a measure of consumption of computational resources.

In another embodiment, the filtering criterion is a difference limit performed by: calculating a plurality of differences between the given score and each of the plurality of potential scores; and filtering out, based on the plurality of differences, the plurality of potential scores having a negative difference from the given score greater than a predetermined difference threshold, to compile a list of plurality of filtered potential scores.

In another embodiment, the filtering criterion is a difference limit performed by: calculating a plurality of differences between the given score and each of the plurality of potential scores; and filtering out, based on the plurality of differences, the plurality of potential scores having a positive difference from the given score greater than a predetermined difference threshold, to compile a list of plurality of filtered potential scores.

In another embodiment, the filtering criterion is a fraction limit performed by: calculating a ratio between the each of the plurality of potential scores and the given score; and filtering out, based on the plurality of ratios, the plurality of potential scores having a ratio greater than a predetermined ratio threshold, to compile a list of plurality of filtered potential scores.

In another embodiment, the predetermined restriction on processor operation is a timeout limit, wherein the processor is configured to terminate evaluation of a potential working state or cease generating additional potential working states after a predetermined time period has elapsed. The timeout limit may be a fixed time limit or may vary based on the stage of evaluation or the complexity of the working state being analyzed.

In another embodiment, the predetermined restriction on processor operation is a node search limit, wherein the processor is configured to limit the number of nodes explored during evaluation of potential working states. In embodiments utilizing tree search algorithms such as min-max algorithm, alpha-beta pruning, or Monte Carlo tree search, the node search limit restricts the maximum number of nodes that may be visited or expanded during the search process. The node search limit may be applied globally across all potential working states or may be allocated per potential working state.

In another embodiment, the predetermined restriction on processor operation is a measure of consumption of computational resources, wherein the processor is configured to limit at least one of: CPU usage, memory allocation, processing cycles, cache utilization, or network bandwidth during evaluation of potential working states. The computational resource restriction may specify a maximum percentage of available CPU resources, a maximum amount of memory that may be allocated, or a maximum number of processing cycles that may be consumed during the evaluation process.

In another embodiment, the plurality of potential working states are developed from the given working state through one or more intermediate stages, each intermediate stage comprising a plurality of intermediate potential working states; wherein the given working state constitutes an initial stage and the plurality of potential working states constitute a final stage; and wherein the working states in each stage are directly developed from each working state in the previous stage; and wherein the processor is further configured to determine a plurality of potential intermediate scores, each corresponding to one of the plurality of intermediate potential working states.

In another embodiment, the intermediate stages are analyzed using a working queue.

In another embodiment, the one or more intermediate stages are chosen randomly from a set of potential intermediate stages.

In another embodiment, the average of all destabilization values is a weighted average of values, each corresponding to potential working state, based on the scores of the intermediate stages between the initial stage and the corresponding potential working state.

In another embodiment, the average of all destabilization values is a weighted average of values, each corresponding to potential working state, that are the sum of scores of intermediate stages of a certain path between the given working state and the corresponding potential working state

In another embodiment, the processor is configured to perform the evaluation of the plurality of intermediate potential working states in each of the one or more intermediary stages under at least one of: a filtering criterion based on intermediate scores, or a predetermined restriction on processor operation.

In another embodiment, the threshold of the filtering criterion or the predetermined restriction decreases exponentially with each additional stage.

In another embodiment, the filtering criterion is a difference limit performed by: calculating a plurality of differences between a plurality of scores of each working state in each stage and the score of the working state in previous stage from which it is directly developed; and filtering out, based on the plurality of differences, the plurality of scores having a negative difference from the score in the previous stage they are directly developed from, greater than a predetermined difference threshold, to compile a list of plurality of filtered potential scores.

In another embodiment, the filtering criterion is a difference limit performed by: calculating a plurality of differences between a plurality of scores of each working state in each stage and the score of the working state in previous stage from which it is directly developed; and filtering out, based on the plurality of differences, the plurality of scores having a positive difference from the score in the previous stage they are directly developed from, greater than a predetermined difference threshold, to compile a list of plurality of filtered potential scores.

In another embodiment, the filtering criterion is a fraction limit applied to scores beyond a predetermined threshold.

In another embodiment, a conversion function of the form

$$f ( x ) := {C ( \frac{x - μ}{μ} )}^{2}$$

is used before applying the filtering criterion when the score exceeds a predetermined limit. This is done in the embodiment of chess in order to convert fraction based score (used in a game with significant advantage for one side) to a score similar to pawn-loss score in a relatively equal position.

In another embodiment of the present invention, the method further comprising at least one sensor coupled to the processor, wherein the data representing the given working state is generated by the at least one sensor. The term “sensor” in this and all other embodiments of the invention may refer to any device, component, or module configured to detect, measure, monitor, or otherwise respond to a physical, chemical, biological, electrical, optical, environmental, or operational parameter, and to generate corresponding data or signals. The term “sensor” includes, without limitation, physical or mechanical sensors (such as position, motion, displacement, force, pressure, proximity, vibration, level, and flow sensors), environmental sensors (including temperature, humidity, light, sound, and air-quality sensors), chemical sensors (including gas, pH, ion-selective, and electrochemical sensors), biological or biomedical sensors (including biometric and biosensing devices), electrical or electronic sensors (including voltage, current, impedance, magnetic-field, and power sensors), optical sensors (including infrared detectors, laser-based rangefinders, optical encoders, and imaging sensors), radio-frequency and electromagnetic sensors (including radar-based detectors, RFID readers, and related modules), navigation and location sensors (including GNSS receivers, inertial measurement units, and magnetometers), structural-integrity sensors (including stress, strain, deformation, crack-detection, and corrosion sensors), and any combination or functional equivalent thereof.

In another embodiment, the processor is configured to run a game engine configured for assessment of stability of a given state of at least one player in a game with two or more players

According to another embodiment, the game engine is configured for assessment of stability of a given state in a two-player board game, wherein the method comprising an odd number of intermediary stages, thereby assessing the stability of the given state in reference to a future turn of a second player playing against a player playing the given state.

According to another embodiment, the game engine is configured for assessment of stability of a given state in a two-player board game, wherein the method comprising an even number of intermediary stages, thereby assessing the stability of the given state in reference to a future turn of a first player playing the given state.

According to another embodiment, the at least one player includes a virtual player controlled by the game engine, and the game engine is configured to compute and perform a move of the virtual player, wherein the move changes at least one parameter to form an optimized working state characterized by a higher stability score. The assessment of stability of given states and potential states, and the computation of the move may be based on one or more artificial-intelligence techniques implemented by the game engine.

In accordance with another embodiment, the method is configured for assessment of stability of a given state in a strategic game, including board games and card games.

In one embodiment, the strategic game is a two-player board game selected from chess, checkers, Go, backgammon, or similar games where working states comprise board positions and possible moves.

In another embodiment, the strategic game is a card game such as poker, wherein the working state comprises a player's hand, community cards (if applicable), betting position, stack size, and opponent behaviors; and wherein potential working states represent outcomes following different player actions including betting, calling, raising, folding, or checking.

In a further embodiment, the strategic game is bridge, wherein the working state comprises the current hand distribution, bidding history, cards played, and partnership information; and wherein potential working states represent outcomes following different plays or bids.

In accordance with another embodiment, the method is configured for assessment of stability of a given board position in a game of chess.

In such embodiment, the parameters may include castling rights and repeat positions, and the method could be implemented as follows:

### Define:

$${D}_{turn} := \{ \begin{matrix}0 & if x \geq 0 and it ' s White ' s turn \\ 0 & if x \leq 0 and it ' s Black ' s turn \\ x & otherwise\end{matrix}$$

Given a specific arrangement of pieces on a chessboard:
1. Calculate the pawn-loss score of the current arrangement p.
2. Calculate the pawn-loss score for every possible move of the player.
3. Compute using a weak engine the difference between the score of the current arrangement and the score of each possible move for that player.
4. Filter out moves with a score difference below a certain threshold (indicating a significantly worse position).
5. Repeat steps 1 to 4 for each possible move of the second player in response to the remaining possible moves of the first player after filtering.
6. Repeat steps 1 to 4 for each possible move of the first player in response to the remaining possible moves of the second player after filtering.
7. Denote all reasonable positions of depth das a set L Denote calculation of pawn loss score by strong engine as eval (pos).
8. If the [μ]>C where Cis some constant, use:

$$V := {\sum }_{l ∈ L} {e}^{- {{C}_{2} ( \frac{{D}_{turn ( l )}^{( eval ( l ) - μ )}}{μ} )}^{2}}$$

9. Otherwise:

$$V := {\sum }_{l ∈ L} {e}^{- {{C}_{1} ( \frac{{D}_{turn ( l )}^{( eval ( l ) - μ )}}{μ} )}^{2}}$$

10. Denote stability by

$$\frac{V}{\vert L \vert}$$

According to another embodiment of the present invention, the method is configured for assessment of stability of a given board position in a game of checkers.

In accordance with another embodiment of the present invention, the method is configured for assessment of stability of a configuration of a vehicle, wherein the score of each potential working state represents the change in performance of the vehicle in relation to the working state it is directly developed from.

In accordance with another embodiment of the present invention, the method is configured for assessment of stability of a configuration of an automated computer-controlled process, wherein the score of each potential working state represents the change in performance of the automated computer-controlled process in relation to the working state it is directly developed from.

In accordance with another embodiment of the present invention, the method is configured for assessment of stability of a configuration of a biological process, wherein the score of each potential working state represents the change in performance of the biological process in relation to the working state it is directly developed from.

In accordance with another embodiment of the present invention, the method is configured for assessment of stability of a configuration of a chemical process, wherein the score of each potential working state represents the change in performance of the chemical process in relation to the working state it is directly developed from.

In another embodiment, each of the plurality of potential working states is different from the given working state by at least one of the plurality of parameters.

In another embodiment, the score of the working configuration is based on a combination of at least two of the plurality of parameters, wherein the score represents the optimality of the working configuration.

In another embodiment, the step of determination of potential scores of each of the plurality of potential working states is based on at least two of the plurality of parameters in each of the plurality of potential working states, wherein each of the plurality of potential scores represents the optimality of the potential working state it is associated with.

In another embodiment, the processor is configured to compute the given score of each working state based on a simulation of a performance of the working state under the combination of the plurality of parameters in it.

In another embodiment, the mean of the scoring distribution function is a function conditioned on the given score that yields values between 0 and 1 for every potential score, and is set to yield 1 at the given score. In this case, the scoring distribution function can't be a probability distribution.

In another embodiment, the scoring distribution function is a gaussian centered at the given score μ where C is a constant

$${f}_{μ} ( x ) := {e}^{- {C ( x - μ )}^{2}} .$$

This definition is inspired by the normal distribution, but is not normalized to be a probability distribution.

In another embodiment, the scoring distribution function considering the fraction of the score relative to the give centered at the given score μ where C is a constant:

$${f}_{μ} ( x ) := {e}^{- {C ( \frac{x - μ}{μ} )}^{2}} .$$

This is done in the embodiment of chess in order to convert fraction-based score (used in a game with significant advantage for one side) to a score similar to a pawn-loss score in a relatively equal position.

In another embodiment of the present invention, the processor is further configured to apply a stability calculation model to determine an initial stability score of the working configuration, wherein the stability calculation model is configured to weight each component based on its influence on overall stability, and wherein the weighting factors are dynamically adjusted based on environmental data input.

In another embodiment, the processor is further configured to iteratively adjust the stability score in response to variations in environmental data input, wherein the environmental data input comprises real-time measurements from at least one sensor monitoring the working configuration.

In another embodiment, the processor is further configured to output a stability assessment of the working configuration, including a final stability score and a recommendation for configuration adjustments if the final stability score is below a predefined stability threshold.

In another embodiment, the processor is further configured to automatically generate a report summarizing the stability assessment and adjustments recommended, wherein the report is stored in a non-transitory memory and accessible to users via a user interface.

Another preferred embodiment of the present invention relates to a computer-based system for assessing stability of a given working state in a state-changing process, comprising a computing device with a processor, the processor is configured to perform the following tasks: receive data representing a given working state, wherein the working state comprises a plurality of components and a plurality of parameters, each of said plurality of components is associated with at least one of said plurality of parameters; determine a given score of the given working state based on at least one of the plurality of parameters, wherein the given score represents the optimality of the given working state; evaluate a plurality of potential working states that may be developed from the given working state; determine a plurality of potential scores, each corresponding to one of the plurality of potential working states; arrange the given score and plurality of potential scores along a scoring distribution function representing a range of destabilization values; assign a destabilization value within the range of destabilization values to each of the plurality of potential scores based on its position on the scoring distribution function; compute a stability score of the given working state, wherein the stability score is the average of all destabilization values assigned to the plurality of potential scores.

In another embodiment, the system further comprising a user interface, wherein the processor is configured to display the stability score of the given working state on the user interface.

In another embodiment, the system further comprising at least one sensor coupled to the processor, wherein the at least one sensor is configured to measure one or more of the plurality of components and output one or more parameters associated with the one or more of the plurality of components to the processor.

In another embodiment of the system, the processor is further configured to: compute, based on the stability score of the given working state, at least one recommendation of an optimized working state characterized by a higher stability score; wherein the optimized working state is different from the given working state by at least one parameter.

In another embodiment of the system, the processor issues a command to change at least one parameter to switch from the given working state to one of the at least one recommendation of an optimized working state.

In another embodiment of the system, the processor is further configured to display the at least one recommendation on a user interface coupled to the processor, and obtain an instruction to switch from the given working state to one of the at least one recommendation of an optimized working state.

In another embodiment of the system, the state-changing process is performed by the processor.

In another embodiment of the system, the state-changing process is performed by at least one device electronically controlled by the processor.

In another embodiment of the system, the processor is further configured to analyze a combination of at least one of the plurality of parameters in the given working state to determine the given score of the given working state, and a combination of at least one of the plurality of parameters in each of the plurality of potential working states to determine the potential score of the potential working state.

In another embodiment of the system, the processor is further configured to receive the given score of the given working state and the potential score of each of the plurality of potential working states from a database of working state scores stored in a non-transitory memory.

In another embodiment of the system, the processor is further configured to receive the plurality of potential working states that may be developed from the given working state from a database of working states stored in a non-transitory memory.

In another embodiment of the system, the processor is configured to perform the evaluation of the plurality of potential working states under at least one predetermined restriction, being a difference limit, a fraction limit, a timeout limit, a node search limit a measure of consumption of computational resources.

In another embodiment of the system, the plurality of potential working states are developed from the given working state through one or more intermediate stages, each intermediate stage comprising a plurality of intermediate potential working states; wherein the given working state constitutes an initial stage and the plurality of potential working states constitute a final stage; and wherein the working states in each stage are directly developed from each working state in the previous stage; and wherein the processor is further configured to determine a plurality of potential intermediate scores, each corresponding to one of the plurality of intermediate potential working states.

In another embodiment of the system, the system further comprising at least one sensor coupled to the processor, wherein the data representing the given working state is generated by the at least one sensor.

In another embodiment of the system, the system is configured for assessment of stability of a configuration of a vehicle, wherein the score of each potential working state represents the change in performance of the vehicle in relation to the working state it is directly developed from.

In another embodiment of the system, the system is configured for assessment of stability of a configuration of an automated computer-controlled process, wherein the score of each potential working state represents the change in performance of the automated computer-controlled process in relation to the working state it is directly developed from.

In another embodiment of the system, the system is configured for assessment of stability of a configuration of a biological process, wherein the score of each potential working state represents the change in performance of the biological process in relation to the working state it is directly developed from.

In another embodiment of the system, the system is configured for assessment of stability of a configuration of a chemical process, wherein the score of each potential working state represents the change in performance of the chemical process in relation to the working state it is directly developed from.

In another embodiment of the system, the processor is configured to compute the score of each working state based on a simulation of a performance of the working state under the combination of the plurality of parameters in it.

### BRIEF DESCRIPTION OF THE DRAWINGS

FIG. 1 is an illustration of the main steps of a preferred embodiment of the method of the present disclosure.

FIG. 2 depicts the steps of an embodiment of the method applied to assess the stability of a configuration of a vehicle.

FIG. 3 depicts the main components involved in a system for stability assessment according to the present disclosure.

FIG. 4 depicts the steps of an embodiment of the method applied to an engineering scenario that involves intermediate steps.

FIG. 5 depicts the steps of an embodiment of the method applied to assessing chess positions.

### DETAILED DESCRIPTION OF THE DRAWINGS

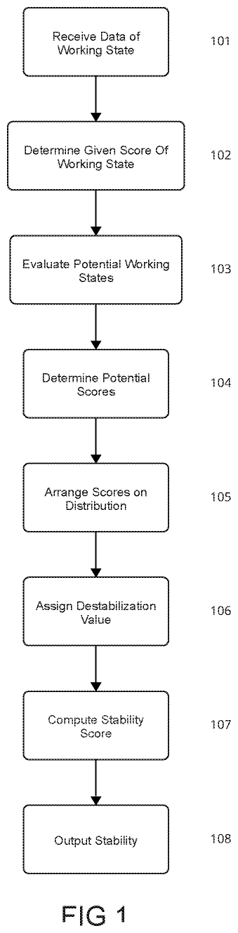

FIG. 1 illustrates an embodiment of the present invention relating to a computer-implemented method for assessing stability of a given working state in a state-changing process. The method consists of the following steps performed by a processor of a computing device. In step 101, the processor receives data representing a given working state, wherein the working state comprises a plurality of components and a plurality of parameters, each of said plurality of components is associated with at least one of said plurality of parameters. In step 102, the processor determines a given score of the given working state based on at least one of the plurality of parameters, wherein the given score represents the optimality of the given working state. According to various embodiments, the given score may be calculated by the processor, calculated by another processor of another computing device and sent to the processor via a network, or retrieved from a score database stored on a non-transitory memory in the computing device of the processor or another computing device. In step 103, the processor evaluates a plurality of potential working states that may be developed from the given working state. In step 104, the processor determines a plurality of potential scores, each corresponding to one of the plurality of potential working states. In step 105, the processor arranges the given score and plurality of potential scores along a scoring distribution function representing a range of destabilization values. Each destabilization value may indicate how a working state associated therewith is stable. In step 106, the processor assigns a destabilization value within the range of destabilization values to each of the plurality of potential scores based on its position on the scoring distribution function. In step 107, the processor computes a stability score of the given working state, wherein the stability score is the average of all destabilization values assigned to the plurality of potential scores. In step 108, the processor outputs the stability score through a user interface.

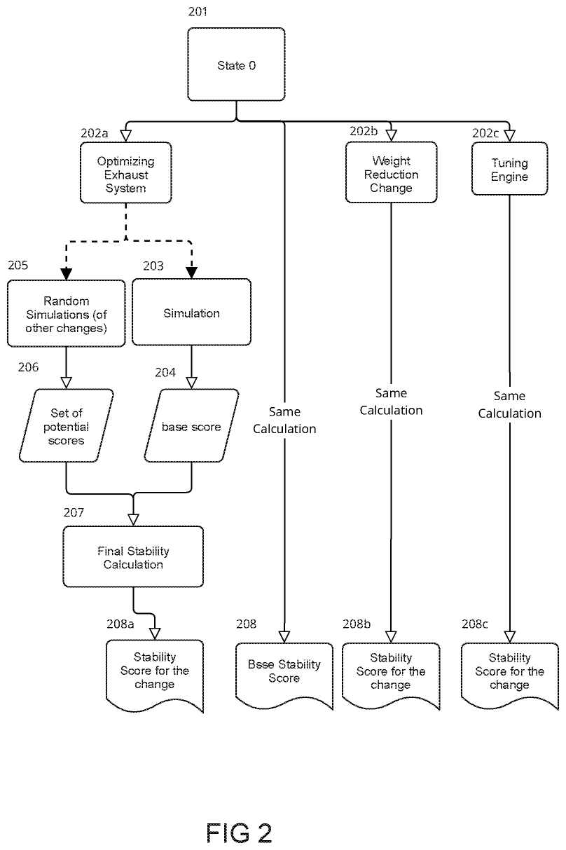

FIG. 2 illustrates an embodiment of the method disclosed herein configured for assessment of stability of a configuration of a vehicle, wherein the score of each potential working state represents the change in performance of the vehicle in relation to the working state it is directly developed from. In this embodiment the vehicle may be a competitive vehicle in a motor sports tournament such as Formula 1 or Motocross GP. The initial stage 201 represents “State 0”, being the given working state of the participating vehicle, whereas the components the working state is composed of may include various factors that influence the vehicle's performance such as gear shift timing, vehicle's weight, engine's tuning and exhaust system's operation. Each of these components has at least one parameter reflecting its current state. The combination of all parameters relating to these components define the given working state of the vehicle. At a given point in time during the tournament, such as during a pit stop, or before the race, the vehicle's crew may perform changes in some of the components, such as tuning the engine and replacing the vehicle's tyres, which affect the performance of the vehicle during the remainder of the tournament. Alternatively, a processor controlling functions in the vehicle may issue a command to change a specific parameter of a controlled component, that would result in a different, more stable working state of the vehicle.

Each of these changes would put the vehicle in a different working state, while there are multiple potential working states that the vehicle may be adjusted to by making one or more changes in the parameters of the given working state. Some changes may appear to be useful in the short term, but later turn out to be counterproductive as they impact the stability of the vehicle's performance in the longer term.

We want to evaluate the extent to which each suggested change in working state would destabilize the vehicle's configuration. We therefore apply the current method for every suggested change, thereby concluding its stability. Our method internally uses a simulator to assess the score of each configuration. In our case, the score might be an average lap time of the vehicle in the working state. Or it might be another measure of the performance or efficiency of the vehicle.

The stability score for different working states, together with the raw score, would help us assess whether it would be advisable to transition to a more stable working state. It can be extremely beneficial for maintaining or improving the vehicle's performance in the long term.

Applying the current method to evaluate the extent to which each suggested change would destabilize the vehicle's configuration, and thereby concluding the stability of the suggested working state to assess whether it would be advisable to transition to a more stable working state, can be extremely beneficial for maintaining or improving the vehicle's performance in the long term.

In the example shown here, three suggested working states that may be developed from given working state 201 are evaluated, being a working state after tuning the engine 202a, a working state after a particular weight reduction change 202b and a working state after optimizing the exhaust system in a particular way 202c. The method's steps are demonstrated with regard to working state 202c, but is carried out for steps 201, 202b, 202a as well. The processor implementing the method is configured to obtain or compute a score for the given working state 201, evaluate working states 202a, 202b and 202c that may be developed from the given working state 201, and stability scores corresponding to said working states.

First, by communication with an external processor running a simulator or by running a simulator itself, where potential working state 202c is used as an input for the simulator 203 the processor obtains its base score 204. It then randomly selects potential changes to apply that are treated as potential working states and runs them in simulator 213 to reach set of potential scores 214, corresponding to each potential working state that may be developed from potential working state 202c. In the next stage, all scores obtained by the processor are arranged along a scoring distribution function representing a range of destabilization values, and each potential score is assigned a destabilization based on its position on the scoring distribution function, followed by averaging the resulting destabilization values 205, which outputs a stability score 206 for the change. Similar processes are performed with regard to each of the additional working states 202a and 202b.

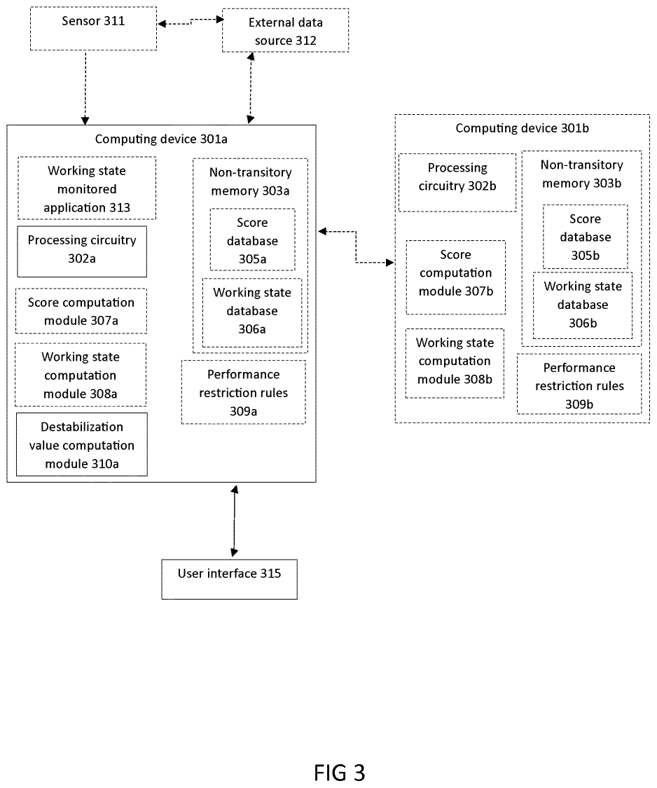

FIG. 3 illustrates a computer-based system for assessing stability of a given working state in accordance with the present disclosure. The system comprising computing device 301a with a processing circuitry 302a, configured to receive data representing a given working state, comprising a plurality of components and a plurality of parameters associated therewith. The data pertaining to the parameters of the given working state may be obtained from one or more sensors 311 monitoring one or more components of the working state. Alternatively, it can be obtained from an external data source 312 which may be data obtained automatically or manually from a machine, vehicle, biological or chemical process or any other element that is characterized by a changing working state. The data can also be generated in the computing device 301a by a working state monitored application 313, such as a chess game application running on computing device 301a. The given score of the given working state is computed by score computation module 307a or retrieved from score database 305a stored on non-transitory memory 303a, or alternatively, computed by score computation module 307b or retrieved from score database 305b stored on non-transitory memory 303b of computing device 301b, being in network communication with computing device 301a. A plurality of potential working states that may be developed from the given working state are computed by working state computation module 308a or retrieved from working state database 306a on non-transitory memory 303a, or alternatively, computed by working state computation module 308b or retrieved from working state database 306b on non-transitory memory 303b of computing device 301b. A plurality of potential scores of the potential working states are computed by score computation module 307a or retrieved from score database 305a stored on non-transitory memory 303a, or alternatively, computed by score computation module 307b or retrieved from score database 305b stored on non-transitory memory 303b of computing device 301b. The stages described thus far may be performed under performance restriction rules 309a or 309b, which may include predetermined restrictions on processor operation (such as limiting CPU usage, computation time, or node search depth) to simulate a less capable machine or human behavior, or filtering criteria (such as score-based filtering) to exclude certain potential working states from analysis. Finally, destabilization value computation module 310a is configured to arrange the given score and plurality of potential scores are arranged along a scoring distribution function representing a range of destabilization values, assign a destabilization value to each of the plurality of potential scores based on its position on the scoring distribution function and compute a stability score of the given working state. The stability score may be outputted through user interface 315, used by processing circuitry 302a for additional steps described herein, or sent back to external data source 312.

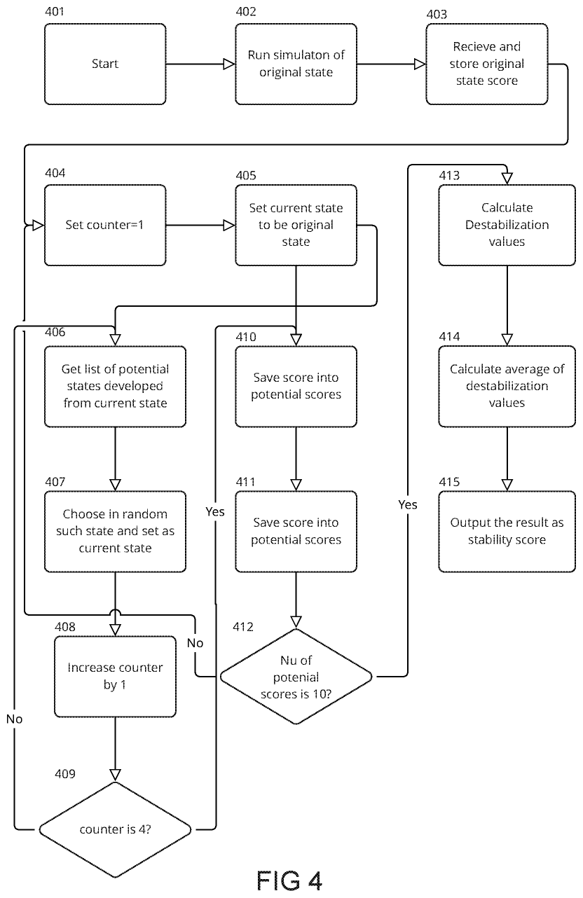

FIG. 4 illustrates an embodiment of a computer-based system and method for assessing stability that is applied to a technical problem, a scenario similar to the one discussed in FIG. 2, but consisting of several intermediate stages chosen at random in order to reach potential working state.

In such embodiments, a simulation has to be carried out to assess the score. The processor implementing the method is configured to compute the stability score of a working state (referred to herein as the original working state). This embodiment goes through several random intermediate working states for obtaining the potential working states, in a way that resembles the Monte Carlo method.

To apply the method, in the first stage 401, the processor communicates with an external processor that runs a simulation of the original working state 402. It then receives and stores the score given to the working state 403 and sets the counter 404 to 1 thereafter.

From here, the processor initializes the current working state by defining it as the original working state 405. It then obtains or calculates a list of potential working states that are developed from the newly defined original working state 406. It then chooses at random one of the potential working states and changes the current state to it 407, constituting an intermediate working state, and incrementing the counter 408 by 1. That is done iteratively 4 times 409 (stages 406 to 409 are repeated for each iteration), until a potential working state is acquired. It then calculates its score using a simulation 410, and saves the scores into potential scores 411.

In this example, the process described so far resulting in a potential score of the potential working state selected in the last iteration is done iteratively 10 times to obtain 10 potential scores 412. Then all potential scores obtained by the processor are arranged along a scoring distribution function representing a range of destabilization values, and each potential score is assigned a destabilization based on its position on the scoring distribution function 413. The final stability computation is performed by calculating the average of all destabilization values 414. In the final stage 415, the processor outputs the stability score through a user interface.

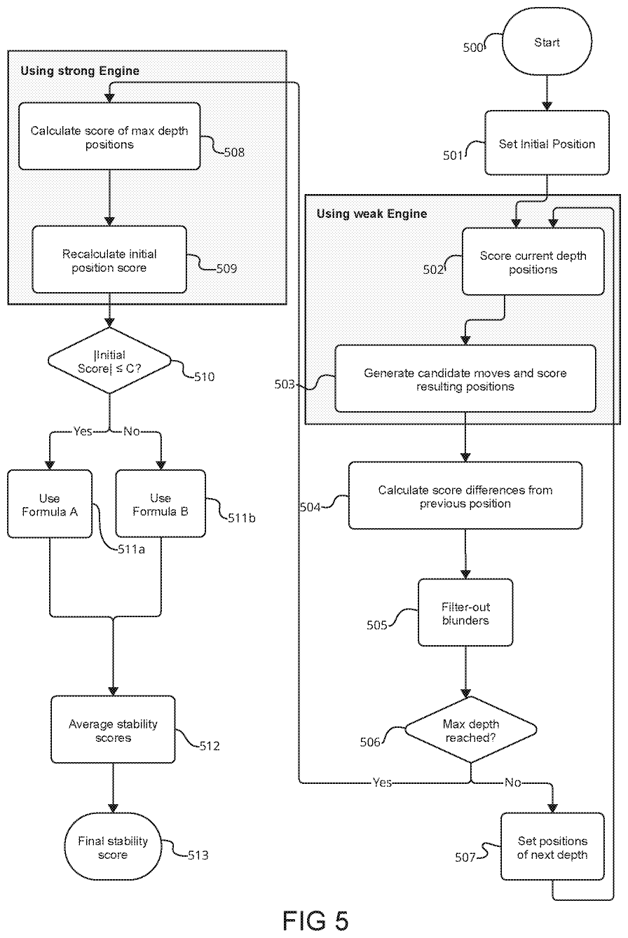

FIG. 5 illustrates a flowchart for a computer-implemented method of assessing the stability of a working state, particularly suitable for two player games with alternating turns, such as chess. This method utilizes two distinct engines, a “weak engine” and a “strong engine” to evaluate and quantify stability, taking into account the potential for future moves to disrupt the current advantage. A “weak engine” and “strong engine” may represent two modes of operation of a processor, where in the “weak engine” mode the processor's operation is restricted by at least one predetermined restriction on processor operation (such as timeout limit, node search limit, or CPU limit), or operates under different configuration parameters (i.e. skill level).

The upper section of the flowchart focuses on the use of a weak engine, characterized by its computational efficiency, for imitating a “weak” human-like play. The weak engine provides a rapid assessment of potential moves and their impact on the game, filtering out moves that lead to a significant decrease in score, as seen from the perspective of a human, yielding potential working states that can be considered reasonable positions achieved by a weaker player.

Upon initiation of the process 500, the first step is executed by setting the initial position 501 as the only position of depth 0 and setting current depth to 0. We calculate the pawn-loss score for the positions of current depth, a metric that quantifies the relative material advantage in terms of pawns. This score, derived in 502, provides a simplified yet insightful evaluation of the position's strength.

Following this, it generates all permissible positions that can result from a single move made from positions of current depth and calculates the score for each of the newly generated positions 503. It will be appreciated that computation of score of current positions 502 and possible positions deriving from it 503 are performed by a weak engine. The processor then computes the difference 504 between each of the scores of permissible positions obtained in 503 and the pawn-loss score of the corresponding parent positions obtained in 502. The difference is calculated from the POV of the player playing the position, that is its gain or loss in terms of centipawns when picking each move. This allows for a quick assessment of the potential gains or losses associated with each move.

Positions that result in a score difference below a predefined threshold are considered blunders and excluded from further analysis 505. This threshold serves as a limit on acceptable score degradation, effectively filtering out moves that would lead to significantly less advantageous positions.

At this point, it is determined whether the maximum depth, set as a limit for the number of moves to be analyzed in advance, has been reached upon completion of the last iteration 506, or, alternatively, the position we started with is of maximal depth−1. If the maximum depth hasn't been reached, the processor sets the filtered positions as the next positions to analyze, and increases current depth 507. It proceeds to invoke the loop that involves repeating steps 502 to 506 for the filtered positions.

Once maximum depth has been achieved, the processing of the position tree is completed. The next stages, detail the utilization of a strong engine, known for its accuracy and in-depth analysis capabilities, to correctly evaluate the reasonable positions identified by the weak engine. They start with 508, in which the processor computes the scores for all positions that have reached the maximum. This evaluation takes into account a broader range of factors compared to the weak engine, resulting in a more precise score.

Next, the pawn-loss score of the initial position, calculated in 502 using the weak engine, is recalculated by the strong engine 509. The process then reaches decision point 510, where the absolute value of the pawn-loss score of the initial position is compared to a predetermined constant “C.” This comparison dictates whether Formula A or Formula B will be used for computing the stability score, based on whether the possible score is very advantageous for one side.

If the absolute value of the pawn-loss score is less than or equal to “C,” Formula A is employed 511a to calculate the stability score.

Formula A is the following:

$${e}^{- {{C}_{1} ( H ( p - μ ) )}^{2}}$$

where C₁ is a constant, p is evaluation of a certain position, μ is the given score and

$$H ( x ) = \{ \begin{matrix}x & if x < 0 \\ 0 & otherwise\end{matrix}$$

Formula B is utilized in imbalance positions 511b.

Formula B is the following:

$${e}^{- {{C}_{2} ( \frac{H ( p - μ )}{μ} )}^{2}}$$

where C₂ is a constant, p is evaluation of a certain position, μ is the given score and H as before.

Finally, the process concludes by averaging the stability scores computed for each position at the maximum depth 512. This average value represents the overall stability score of the initial position, indicating its robustness in case of reasonable moves of certain depth from both players.

The last step yields the stability score. Depending on the depth of calculation (its parity), the potential working scores calculated were either in for positions in which it is white's or black's turn to play, so it is called “white-stability” or “black-stability” respectively.

1. A computer-implemented method for assessing and optimizing stability of a working state in a state-changing process, comprising the following steps performed by at least one processor of at least one computing device:
receiving data representing a given working state in the state-changing process, wherein the working state comprises a plurality of components and a plurality of parameters, each of said plurality of components is associated with at least one of said plurality of parameters;
determining a given score of the given working state based on at least one of the plurality of parameters, wherein the given score represents the optimality of the given working state;
evaluating a plurality of potential working states that may be developed from the given working state;
determining a plurality of potential scores, each corresponding to one of the plurality of potential working states;
arranging the given score and plurality of potential scores along a scoring distribution function representing a range of destabilization values;
assigning a destabilization value within the range of destabilization values to each of the plurality of potential scores based on its position on the scoring distribution function;
computing a stability score of the given working state, wherein the stability score is the average of all destabilization values assigned to the plurality of potential scores.

2. The method of claim 1, wherein the computing device further comprising a user interface and the processor is further configured to display the stability score on the user interface.

3. The method of claim 1, wherein the processor is further configured to:
compute, based on the stability score of the given working state, at least one recommendation of an optimized working state characterized by a higher stability score;
wherein the optimized working state is different from the given working state by at least one parameter.

4. The method of claim 3, wherein the processor issues a command to change at least one parameter to switch from the given working state to one of the at least one recommendation of an optimized working state.

5. The method of claim 3, wherein the processor is further configured to display the at least one recommendation on a user interface coupled to the processor, and obtain an instruction to switch from the given working state to one of the at least one recommendation of an optimized working state.

6. The method of claim 1, wherein the state-changing process is performed by the processor.

7. The method of claim 1, wherein the state-changing process is performed by at least one device electronically controlled by the processor.

8. The method of claim 1, further comprising: analyzing, by the processor, a combination of at least one of the plurality of parameters in the given working state to determine the given score of the given working state, and a combination of at least one of the plurality of parameters in each of the plurality of potential working states to determine the potential score of the potential working state.

9. The method of claim 1, wherein the at least one processor includes a first processor and a second processor of a second computing device in communication with the first processor, and at least one of the following steps performed by the second processor:
evaluating a plurality of potential working states that may be developed from the given working state;
analyzing a combination of at least one of the plurality of parameters in the given working state to determine the given score of the given working state; and
analyzing a combination of at least one of the plurality of parameters in each of the plurality of potential working states to determine the potential score of each potential working state.

10. The method of claim 1, wherein the processor is configured to perform the evaluation of the plurality of potential working states under at least one of: a filtering criterion based on potential scores, or a predetermined restriction on processor operation;
wherein the filtering criterion comprises at least one of a difference limit or a fraction limit; and wherein the predetermined restriction on processor operation comprises at least one of a timeout limit, a node search limit, or a measure of consumption of computational resources.

11. The method of claim 1, wherein the plurality of potential working states are developed from the given working state through one or more intermediate stages, each intermediate stage comprising a plurality of intermediate potential working states;
wherein the given working state constitutes an initial stage and the plurality of potential working states constitute a final stage; and
wherein the working states in each stage are directly developed from each working state in the previous stage; and
wherein the processor is further configured to determine a plurality of potential intermediate scores, each corresponding to one of the plurality of intermediate potential working states.

12. The method of claim 1, further comprising at least one sensor coupled to the processor, wherein the data representing the given working state is generated by the at least one sensor.

13. The method of claim 1, wherein the processor is configured to run a game engine configured for assessment of stability of a given state of at least one player in a game with two or more players.

14. The method of claim 13, wherein the at least one player includes a virtual player controlled by the game engine, and the game engine is configured to compute and perform a move of the virtual player, wherein the move changes at least one parameter to form an optimized working state characterized by a higher stability score.

15. The method of claim 13, wherein the game is chess.

16. The method of claim 1, configured for assessment of stability of a configuration of an automated computer-controlled process, wherein the score of each potential working state represents the change in performance of the automated computer-controlled process in relation to the working state it is directly developed from.

17. The method of claim 1, configured for assessment of stability of a configuration of a biological or chemical process, wherein the score of each potential working state represents the change in performance of the biological or chemical process in relation to the working state it is directly developed from.

18. The method of claim 1, wherein the processor is configured to compute the score of each working state based on a simulation of a performance of the working state under the combination of the plurality of parameters in it.

19. The method of claim 1, configured for assessment of stability of a configuration of a vehicle, wherein the score of each potential working state represents the change in performance of the vehicle in relation to the working state it is directly developed from.

20. A computer-based system for assessing stability of a given working state in a state-changing process, comprising a computing device with a processor, the processor is configured to perform the following tasks:
receive data representing a given working state, wherein the working state comprises a plurality of components and a plurality of parameters, each of said plurality of components is associated with at least one of said plurality of parameters;
determine a given score of the given working state based on at least one of the plurality of parameters, wherein the given score represents the optimality of the given working state;
evaluate a plurality of potential working states that may be developed from the given working state;
determine a plurality of potential scores, each corresponding to one of the plurality of potential working states;
arrange the given score and plurality of potential scores along a scoring distribution function representing a range of destabilization values;
assign a destabilization value within the range of destabilization values to each of the plurality of potential scores based on its position on the scoring distribution function;
compute a stability score of the given working state, wherein the stability score is the average of all destabilization values assigned to the plurality of potential scores.

21. The computer-based system of claim 20, further comprising at least one sensor coupled to the processor, wherein the at least one sensor is configured to measure one or more of the plurality of components and output one or more parameters associated with the one or more of the plurality of components to the processor.
